(19) United States
(12) Patent Application Publication
(10) Pub. No.: US 2023/0035526 A1
(43) Pub. Date: Feb. 2, 2023

(54) INFERENCE DEVICE, DRIVING ASSISTANCE DEVICE, INFERENCE METHOD, AND SERVER

(71) Applicant: Mitsubishi Electric Corporation, Tokyo (JP)

(72) Inventor: Taro OKUDA, Tokyo (JP)

(73) Assignee: Mitsubishi Electric Corporation, Tokyo (JP)

(21) Appl. No.: 17/790,297

(22) PCT Filed: Feb. 26, 2020
(86) PCT No.: PCT/JP2020/007607

§ 371 Date: Jun. 30, 2022

(51) Int. Cl. G06N 20/00

(52) U.S. Cl. CPC G06N 20/00

(57) ABSTRACT

A data acquisition unit to acquire data; an inference unit to infer a first inference result by inputting the data acquired to a first machine learning model that outputs the first inference result by using the data as an input; a similarity calculation unit to calculate a similarity between the data acquired and a second inference result on the basis of the second inference result and the data acquired, the second inference result being inferred by inputting the data acquired to a second machine learning model that outputs the second inference result by using the data as an input; a determination unit to determine whether or not to output the first inference result by comparing the similarity calculated with a threshold for inference result determination; and an output unit to output the first inference result when the determination unit determines to output the first inference result are included.

### CROSS REFERENCE TO RELATED APPLICATIONS

This application is a National Stage of International Application No. PCT/JP2020/007607, filed on Feb. 26, 2020.

### TECHNICAL FIELD

The present disclosure relates to an inference device, a driving assistance device, an inference method, and a server that perform inference using a learned model in machine learning (hereinafter referred to as “machine learning model”).

### BACKGROUND ART

Conventionally, in a field of automatic driving and the like, a technique for performing inference by using a machine learning model is known.

Meanwhile, Patent Literature 1 discloses an information processing apparatus that, in a case where an estimation result generated by using unsupervised data is similar to an estimation result generated by using supervised data, creates teacher information for the unsupervised data on the basis of teacher information included in the supervised data.

### CITATION LIST

### Patent Literatures

Patent Literature 1: JP 2019-87012 A

### SUMMARY OF INVENTION

### Technical Problems

In a case where inference using a machine learning model is performed, there is a case where data greatly different from data input at the time of learning of the machine learning model is input to the machine learning model. As a result, there is a problem that an invalid inference result may be output.

The technique disclosed in Patent Literature 1 is a technique for determining a similarity between supervised data and unsupervised data in training data, and is not a technique for determining a similarity between data to be input at the time of inference and data input at the time of learning. Therefore, it is not possible to use the technique disclosed in Patent Literature 1 for solving the above problem.

The present disclosure has been made to solve the above problem, and an object thereof is to provide an inference device capable of preventing output of an invalid inference result.

### Solution to Problems

An inference device according to the present disclosure includes: processing circuitry to acquire data; to infer a first inference result by inputting the data acquired to at least one first machine learning model that outputs the first inference result by using the data as an input; to calculate a similarity between the data acquired and a second inference result on the basis of the second inference result and the data acquired, the second inference result being inferred by inputting the data acquired to at least one second machine learning model that outputs the second inference result by using the data as an input; to determine whether or not to output the first inference result by comparing the similarity calculated with a threshold for inference result determination; and to output the first inference result in a case where it is determined that the first inference result is to be output.

### Advantageous Effects of Invention

According to the present disclosure, it is possible to prevent output of an invalid inference result.

### BRIEF DESCRIPTION OF DRAWINGS

FIG. 1 is a diagram illustrating a configuration example of an inference device according to a first embodiment.

FIG. 2 is a diagram illustrating a relationship between a first machine learning model and a second machine learning model in the first embodiment.

FIG. 3 is (Equation 1) representing a similarity [S] between vehicle peripheral data and output vehicle peripheral data in the first embodiment.

FIG. 4 illustrates an example of a concept of a threshold for inference result determination statistically set on the basis of a distribution of “correct data similarity” and a distribution of “incorrect data similarity” in the first embodiment.

FIG. 5 is a flowchart for explaining operation of the inference device according to the first embodiment.

FIG. 6 is a flowchart for explaining operation of the inference device in a case where a first inference unit infers driving assistance information after a determination unit determines to output the driving assistance information in the first embodiment.

FIG. 7 is a diagram illustrating a configuration example of an inference device according to a second embodiment.

FIG. 8 is a diagram illustrating an example of a concept of a method in which a second model selection unit selects a select second machine learning model by comparing a similarity for each second machine learning model calculated by a similarity calculation unit with a threshold for inference result determination in the second embodiment.

FIG. 9 is a diagram illustrating an example of a concept of a method in which a provisional second model selection unit selects a provisional second machine learning model on the basis of a representative similarity calculated by a representative similarity calculation unit and learning time similarity information in the second embodiment.

FIG. 10 is a flowchart for explaining operation of the inference device according to the second embodiment.

FIG. 11 is a flowchart for explaining a specific operation of step ST1005 in FIG. 10 in a case where the inference device performs parallel computation to select a select second machine learning model.

FIG. 12 is a flowchart for explaining a specific operation of step ST1005 in FIG. 10 in a case where the inference device performs sequential computation to select a select second machine learning model.

FIG. 13 is a flowchart for explaining operation of the inference device in a case where a first inference unit infers driving assistance information after a determination unit determines to output the driving assistance information in the second embodiment.

FIGS. 14A and 14B are diagrams each illustrating an example of a hardware configuration of the inference device according to the first embodiment or the inference device according to the second embodiment.

FIG. 15 is a diagram illustrating a configuration example of an inference system in which the inference device according to the first embodiment or the inference device according to the second embodiment is provided in a server and the server and a vehicle are connected via a network.

### DESCRIPTION OF EMBODIMENTS

Hereinafter, embodiments of the present invention will be described in detail with reference to the drawings.

### First Embodiment

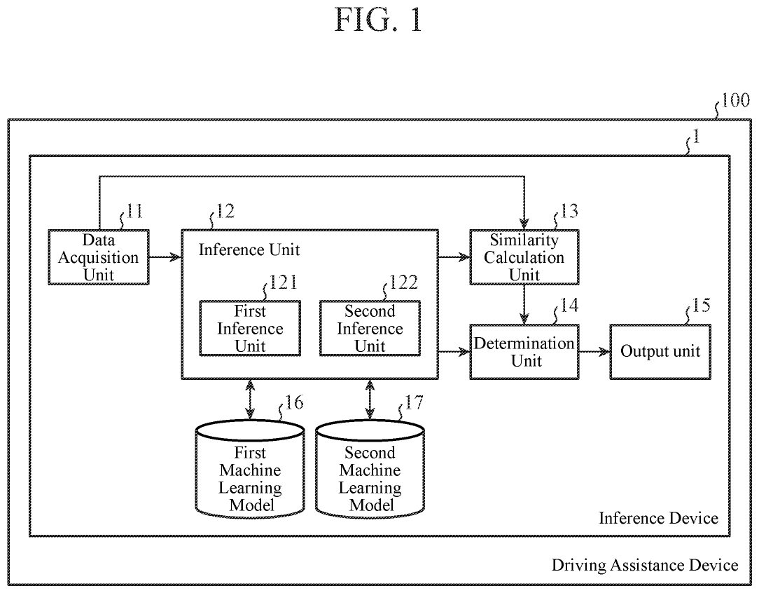

FIG. 1 is a diagram illustrating a configuration example of an inference device 1 according to a first embodiment.

In the first embodiment, the inference device 1 is included in a driving assistance device 100 that outputs information for assisting driving performed by a driver of a vehicle (hereinafter referred to as “driving assistance information”). Note that the vehicle in which the driving assistance device 100 assists the driving has an automatic driving function. Even when the vehicle has the automatic driving function, the driver can drive the vehicle by himself or herself without executing the automatic driving function. The driving assistance device 100 outputs the driving assistance information when the driver drives by himself or herself in the vehicle capable of automatic driving. Specifically, the driving assistance information is, for example, information indicating that an object such as another vehicle, a signal, or a sign around the vehicle has been recognized. The driving assistance device 100 is mounted on a vehicle.

The inference device 1 infers driving assistance information on the basis of data regarding the area around the vehicle (hereinafter referred to as “vehicle peripheral data”) and a first machine learning model 16, and outputs the inferred driving assistance information. The first machine learning model 16 has learned to infer an inference result (hereinafter referred to as “first inference result”) by supervised learning in which correct data corresponding to input data is prepared. In the first embodiment, the first machine learning model 16 has learned to infer the driving assistance information as the first inference result by supervised learning in which correct data corresponding to the vehicle peripheral data is prepared.

At that time, the inference device 1 uses a second machine learning model 17 to determine whether or not the driving assistance information inferred by the first machine learning model 16 is valid. The second machine learning model 17 has learned, by using the same input data as the first machine learning model 16, so that input data and output data that is an inference result (hereinafter referred to as “second inference result”) are equal. In the first embodiment, the second machine learning model 17 has learned to use the vehicle peripheral data as an input, and to output output data having the same content as the vehicle peripheral data (hereinafter referred to as “output vehicle peripheral data”) as the second inference result.

In the first embodiment, the first machine learning model 16 and the second machine learning model 17 are machine learning models learned by deep learning in a neural network.

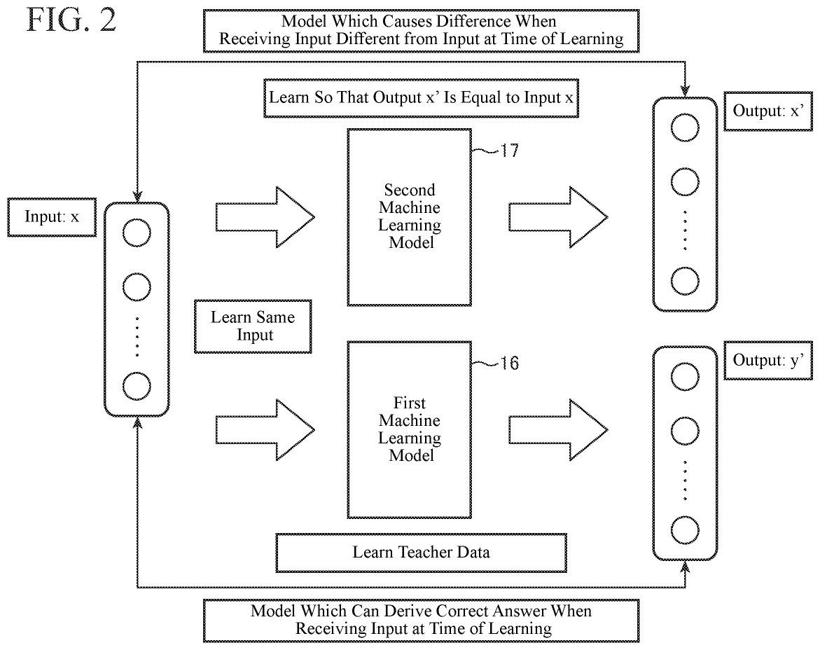

FIG. 2 is a diagram illustrating a relationship between the first machine learning model 16 and the second machine learning model 17 in the first embodiment.

As a premise, an output at the time of inference by neural network depends on a bias in data input at the time of learning (hereinafter referred to as “learning time data”). Therefore, when vehicle peripheral data having the same content as the learning time data of the first machine learning model 16 is input at the time of inference, the first machine learning model 16 is assumed to be capable of deriving a correct answer, in other words, capable of inferring correct driving assistance information.

Here, as described above, the second machine learning model 17 has learned to output data having the same content as the input vehicle peripheral data, that is, to output the output vehicle peripheral data. Therefore, when vehicle peripheral data having a feature close to that of learning time data of the second machine learning model 17 is input to the second machine learning model 17 at the time of inference, a difference between the vehicle peripheral data input to the second machine learning model 17 and the output vehicle peripheral data to be output is reduced. On the other hand, when vehicle peripheral data having a feature different from that of the learning time data of the second machine learning model 17 is input to the second machine learning model 17 at the time of inference, a difference occurs between the vehicle peripheral data input to the second machine learning model 17 and the output vehicle peripheral data to be output. Note that the vehicle peripheral data input to the second machine learning model 17 at the time of inference is the vehicle peripheral data input to the first machine learning model 16 at the time of inference.

In the first embodiment, a degree of whether a feature of the vehicle peripheral data input to the second machine learning model 17 and a feature of the output vehicle peripheral data output at the time of inference are close to each other is referred to as “similarity” between the vehicle peripheral data and the output vehicle peripheral data.

The similarity between the vehicle peripheral data and the output vehicle peripheral data is larger as a difference generated between the vehicle peripheral data input to the second machine learning model 17 at the time of inference and the output vehicle peripheral data output by the second machine learning model 17 is smaller. It can be said that the vehicle peripheral data at the time of inference has a feature closer to that of the learning time data as the similarity between the vehicle peripheral data and the output vehicle peripheral data is larger. When the feature of the vehicle peripheral data at the time of inference is close to the feature of the learning time data, it is assumed that the inferred driving assistance information is correct.

On the other hand, when the difference generated between the vehicle peripheral data input to the second machine learning model 17 at the time of inference and the output vehicle peripheral data output by the second machine learning model 17 is large, the similarity between the vehicle peripheral data and the output vehicle peripheral data is small. It can be said that the vehicle peripheral data at the time of inference is more different in feature from the learning time data as the similarity between the vehicle peripheral data and the output vehicle peripheral data is smaller. When the feature of the vehicle peripheral data at the time of inference is different from the feature of the learning time data, it is assumed that the inferred driving assistance information is not correct.

At the time of inference, the inference device 1 calculates a similarity between the vehicle peripheral data and the output vehicle peripheral data, and determines whether or not driving assistance information is valid on the basis of the calculated similarity.

A method of calculating the similarity in the inference device 1 will be described later. Further, details of a method of determining whether or not the driving assistance information is valid, which is performed by the inference device 1, will be described later.

When it is determined that the driving assistance information inferred on the basis of the first machine learning model 16 is valid, the inference device 1 outputs the driving assistance information to the driving assistance device 100.

Note that, in the first embodiment, the first machine learning model 16 is a machine learning model used for the purpose of acquiring the information indicating that the object has been recognized as described above, but this is merely an example. The first machine learning model 16 is a machine learning model for obtaining any first inference result used for any purpose.

As illustrated in FIG. 1, the inference device 1 includes a data acquisition unit 11, an inference unit 12, a similarity calculation unit 13, a determination unit 14, an output unit 15, the first machine learning model 16, and the second machine learning model 17. Note that, in the first embodiment, as illustrated in FIG. 1, the first machine learning model 16 and the second machine learning model 17 are provided in the inference device 1, but this is merely an example. The first machine learning model 16 and the second machine learning model 17 may be provided at a place that can be referred to by the inference device 1, and that is outside the inference device 1.

The inference unit 12 includes a first inference unit 121 and a second inference unit 122.

The data acquisition unit 11 acquires information on an area around the vehicle.

The information on the area around the vehicle includes, for example, information regarding a position of the vehicle, a captured image obtained by imaging the area around the vehicle, or map information. The data acquisition unit 11 acquires the information on the area around the vehicle from, for example, a global positioning system (GPS) mounted on the vehicle, an imaging device (not illustrated) mounted on the vehicle, or a map information database stored in a server (not illustrated) outside the vehicle.

The data acquisition unit 11 acquires vehicle peripheral data to be input to the first machine learning model 16 and the second machine learning model 17 on the basis of the acquired information on the area around the vehicle. In the first embodiment, the vehicle peripheral data is data indicating one or more feature amounts extracted from the information on the area around the vehicle. The feature amount is a position of the vehicle, a position of another vehicle, a position of a pedestrian, or the like.

The data acquisition unit 11 acquires vehicle peripheral data indicating one or more feature amounts on the basis of the information on the area around the vehicle.

The data acquisition unit 11 outputs the vehicle peripheral data indicating one or more feature amounts to the inference unit 12 and the similarity calculation unit 13. In the first embodiment, the vehicle peripheral data indicating one or more feature amounts is also simply referred to as “vehicle peripheral data”.

The inference unit 12 inputs the vehicle peripheral data acquired by the data acquisition unit 11 to the first machine learning model 16 and thereby infers driving assistance information.

In addition, the inference unit 12 inputs the vehicle peripheral data acquired by the data acquisition unit 11 to the second machine learning model 17 and thereby infers output vehicle peripheral data.

Specifically, the first inference unit 121 of the inference unit 12 inputs the vehicle peripheral data acquired by the data acquisition unit 11 to the first machine learning model 16 and thereby infers the driving assistance information.

The second inference unit 122 of the inference unit 12 inputs the vehicle peripheral data acquired by the data acquisition unit 11 to the second machine learning model 17 and thereby infers the output vehicle peripheral data.

The first inference unit 121 outputs the inferred driving assistance information to the determination unit 14. The second inference unit 122 outputs the inferred output vehicle peripheral data to the similarity calculation unit 13.

On the basis of the output vehicle peripheral data inferred by the second inference unit 122 by inputting the vehicle peripheral data acquired by the data acquisition unit 11 to the second machine learning model 17 and the vehicle peripheral data acquired by the data acquisition unit 11, the similarity calculation unit 13 calculates a similarity between the vehicle peripheral data acquired by the data acquisition unit 11 and the inferred output vehicle peripheral data.

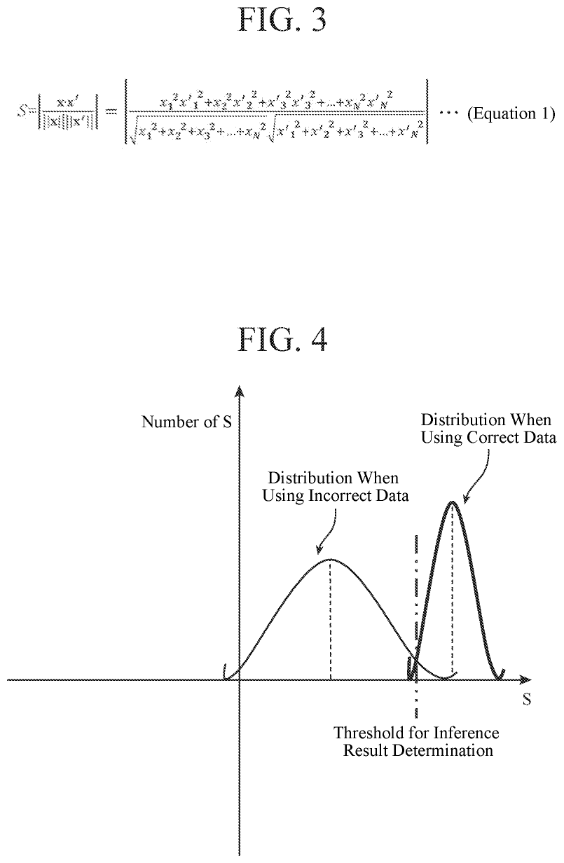

Here, FIG. 3 is (Equation 1) representing a similarity [S] between vehicle peripheral data and output vehicle peripheral data in the first embodiment.

In (Equation 1), “x” represents vehicle peripheral data input to the second machine learning model by the second inference unit 122, and “x” represents output vehicle peripheral data inferred by the second inference unit 122 by inputting the vehicle peripheral data to the second machine learning model.

As illustrated in FIG. 3, in the first embodiment, the similarity between the vehicle peripheral data and the output vehicle peripheral data is expressed by a cosine similarity using the vehicle peripheral data and the output vehicle peripheral data. and “x” are vectors x={x₁, x₂, x₃, . . . , x_{N}} and x′={x′₁, x′₂, x′₃, . . . , x′_{N}} each having N elements. The cosine similarity is determined as one value by (Equation 1) regardless of the number of feature amounts included in the vehicle peripheral data and the output vehicle peripheral data. The similarity increases as the vehicle peripheral data and the output vehicle peripheral data have closer features.

The similarity calculation unit 13 calculates a similarity between the vehicle peripheral data and the output vehicle peripheral data on the basis of (Equation 1) expressed in FIG. 3.

The similarity calculation unit 13 outputs the calculated similarity to the determination unit 14.

The determination unit 14 determines whether or not to output the driving assistance information inferred by the first inference unit 121 by comparing the similarity calculated by the similarity calculation unit 13 with a threshold for inference result determination.

Specifically, the determination unit 14 first sets the threshold for inference result determination.

The determination unit 14 sets the threshold for inference result determination on the basis of “correct data similarity” calculated on the basis of “correct test data” at the time of testing the first machine learning model 16 and “correct inference result” and “incorrect data similarity” calculated on the basis of “incorrect test data” at the time of testing the first machine learning model 16 and “incorrect inference result”.

“Correct test data” is vehicle peripheral data which is used as test data, and which, when input to the first machine learning model 16 at the time of testing the first machine learning model 16, causes correct driving assistance information to be output. Note that the vehicle peripheral data as the test data includes one or more feature amounts.

“Correct inference result” is output vehicle peripheral data output when the “correct test data” is input to the second machine learning model 17.

“Correct data similarity” is a similarity between the “correct test data” and the “correct inference result” calculated on the basis of the “correct test data” and the “correct inference result”.

“Incorrect test data” is vehicle peripheral data which is used as test data, and which, when input to the first machine learning model 16 at the time of testing the first machine learning model 16, causes incorrect driving assistance information to be output.

“Incorrect inference result” is output vehicle peripheral data output when the “incorrect test data” is input to the second machine learning model 17.

“Incorrect data similarity” is a similarity between the “incorrect test data” and the “incorrect inference result” calculated on the basis of the “incorrect test data” and the “incorrect inference result”.

The determination unit 14 may calculate “correct data similarity” and “incorrect data similarity” in the same manner as the similarity calculation unit 13 calculates the similarity between the vehicle peripheral data and the output vehicle peripheral data (see (Equation 1) in FIG. 3).

It is assumed that “correct test data”, “correct inference result”, “incorrect test data”, and “incorrect inference result” are stored in a storage unit (not illustrated) that can be referred to by the inference device 1 at the time of testing the first machine learning model 16 and the second machine learning model 17.

The determination unit 14 statistically sets the threshold for inference result determination on the basis of a distribution of “correct data similarity” and a distribution of “incorrect data similarity”.

Here, FIG. 4 illustrates an example of a concept of the threshold for inference result determination statistically set on the basis of the distribution of “correct data similarity” and the distribution of “incorrect data similarity” in the first embodiment.

In a case where vehicle peripheral data including a plurality of feature amounts can be input to the first machine learning model 16 and the second machine learning model 17 at the time of inference, the first machine learning model 16 and the second machine learning model 17 are tested using test data including the plurality of feature amounts.

In FIG. 4, the horizontal axis indicates “correct data similarity” or “incorrect data similarity”. The vertical axis indicates the number of “correct data similarity” or the number of “incorrect data similarity”.

When the threshold for inference result determination is set as described above, the determination unit 14 determines whether or not to output the driving assistance information inferred by the first inference unit 121 by comparing the similarity calculated by the similarity calculation unit 13 with the threshold for inference result determination.

Specifically, in the first embodiment, when the similarity calculated by the similarity calculation unit 13 is larger than the threshold for inference result determination, the determination unit 14 determines to output the driving assistance information inferred by the first inference unit 121.

The determination unit 14 outputs, to the output unit 15, a determination result as to whether or not to output the driving assistance information inferred by the first inference unit 121. When determining to output the driving assistance information inferred by the first inference unit 121, the determination unit 14 outputs the driving assistance information to the output unit 15 in association with the determination result.

Note that, in the first embodiment, the similarity is represented by the cosine similarity using the vehicle peripheral data and the output vehicle peripheral data. Therefore, it can be said that the feature of the vehicle peripheral data and the feature of the output vehicle peripheral data are closer to each other as the similarity is larger. Therefore, when the similarity calculated by the similarity calculation unit 13 is larger than the threshold for inference result determination, the determination unit 14 determines to output the driving assistance information inferred by the first inference unit 121, but this is merely an example.

Depending on a similarity setting method, it can be said that the feature of the vehicle peripheral data and the feature of the output vehicle peripheral data are less close to each other as the similarity is larger. As a specific example, for example, it is assumed that the similarity is represented by a difference between vehicle peripheral data and output vehicle peripheral data. In this case, it can be said that the feature of the vehicle peripheral data and the feature of the output vehicle peripheral data are less close to each other as the similarity, in other words, the difference is larger. The determination unit 14 determines to output the driving assistance information when the similarity is smaller than the threshold for inference result determination.

As described above, the case where the determination unit 14 determines to output the driving assistance information is not limited to the case where the similarity is larger than the threshold for inference result determination. The determination unit 14 is only required to determine whether or not to output the driving assistance information by comparing the similarity with the threshold for inference result determination.

Further, in the first embodiment, as described above, the determination unit 14 calculates “correct data similarity” and “incorrect data similarity” and sets the threshold for inference result determination, but this is merely an example. For example, when calculating the similarity between the vehicle peripheral data acquired by the data acquisition unit 11 and the output vehicle peripheral data inferred by inputting the vehicle peripheral data to the second machine learning model 17, the similarity calculation unit 13 may calculate “correct data similarity” and “incorrect data similarity” and output them to the determination unit 14. The determination unit 14 sets the threshold for inference result determination on the basis of “correct data similarity” and “incorrect data similarity” output from the similarity calculation unit 13. Furthermore, for example, at the time of testing the first machine learning model 16 and the second machine learning model 17, “correct data similarity” and “incorrect data similarity” may be calculated, and the threshold for inference result determination may be set on the basis of “correct data similarity” and “incorrect data similarity”. It is assumed that the threshold for inference result determination set at the time of testing is stored in the storage unit.

The threshold for inference result determination is only required to be set before the determination unit 14 uses the threshold for inference result determination to determine whether or not to output the driving assistance information inferred by the first inference unit 121.

When the determination unit 14 determines to output the driving assistance information inferred by the first inference unit 121, the output unit 15 outputs the driving assistance information to the driving assistance device 100.

When the determination unit 14 determines not to output the driving assistance information inferred by the first inference unit 121, the output unit 15 outputs notification information for notifying the driving assistance device 100 that automatic driving is not possible.

When the notification information is output from the output unit 15, the driving assistance device 100 inquires of a driver of the vehicle whether or not to switch from the automatic driving to manual driving. Specifically, for example, an inquiry unit (not illustrated) of the driving assistance device 100 displays a message as to whether or not to switch from the automatic driving to the manual driving on a touch panel display (not illustrated) provided in the vehicle. The driver checks the touch panel display, touches the touch panel display, or the like, and thereby inputs an instruction as to whether or not to switch to the manual driving. When an instruction to switch to the manual driving is input, a driving control unit (not illustrated) of the driving assistance device 100 switches the vehicle to manual driving control. When the instruction to switch to the manual driving is not input, the driving control unit of the driving assistance device 100 performs control to automatically stop the vehicle.

The operation of the inference device 1 according to the first embodiment will be described.

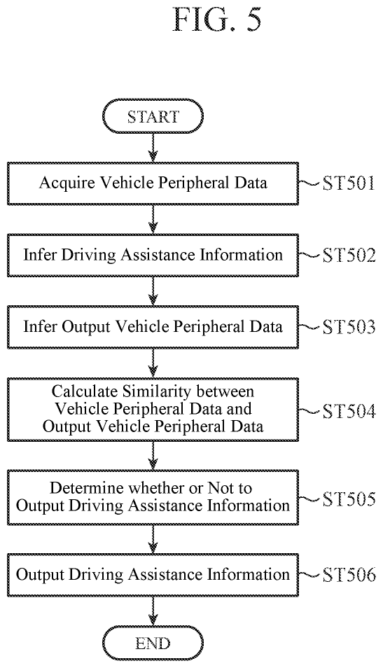

FIG. 5 is a flowchart for explaining the operation of the inference device 1 according to the first embodiment.

The data acquisition unit 11 acquires vehicle peripheral data to be input to the first machine learning model 16 and the second machine learning model 17 on the basis of acquired information on an area around the vehicle (step ST501).

The data acquisition unit 11 outputs the acquired vehicle peripheral data to the inference unit 12 and the similarity calculation unit 13.

The first inference unit 121 of the inference unit 12 inputs the vehicle peripheral data acquired by the data acquisition unit 11 in step ST501 to the first machine learning model 16 to infer driving assistance information (step ST502).

The first inference unit 121 outputs the inferred driving assistance information to the determination unit 14.

The second inference unit 122 of the inference unit 12 inputs the vehicle peripheral data acquired by the data acquisition unit 11 in step ST501 to the second machine learning model 17 to infer output vehicle peripheral data (step ST503).

The second inference unit 122 outputs the inferred output vehicle peripheral data to the similarity calculation unit 13.

On the basis of the output vehicle peripheral data inferred by the second inference unit 122 in step ST503 and the vehicle peripheral data acquired by the data acquisition unit 11 in step ST501, the similarity calculation unit 13 calculates a similarity between the vehicle peripheral data acquired by the data acquisition unit 11 and the output vehicle peripheral data (step ST504).

The similarity calculation unit 13 outputs the calculated similarity to the determination unit 14.

The determination unit 14 determines whether or not to output the driving assistance information inferred by the first inference unit 121 in step ST502 by comparing the similarity calculated by the similarity calculation unit 13 in step ST504 with the threshold for inference result determination (step ST505).

The determination unit 14 outputs, to the output unit 15, a determination result as to whether or not to output the driving assistance information inferred by the first inference unit 121.

When the determination unit 14 determines to output the driving assistance information inferred by the first inference unit 121 in step ST505, the output unit 15 outputs the driving assistance information to the driving assistance device 100 (step ST506).

When the determination unit 14 determines not to output the driving assistance information inferred by the first inference unit 121, the output unit 15 outputs notification information for notifying the driving assistance device 100 that automatic driving is not possible.

Note that, in FIG. 5, the operation of the inference device 1 is performed in the order of step ST502 and then step ST503, but the order of the operation of step ST502 and the operation of step ST503 may be reversed in FIG. 5.

Furthermore, in the operation description using FIG. 5, in the inference device 1, the first inference unit 121 of the inference unit 12 infers the driving assistance information (step ST502) before the determination unit 14 determines whether or not to output the driving assistance information (step ST505), and the determination unit 14 outputs the driving assistance information inferred by the first inference unit 121 when determining to output the first inference result. However, this is merely an example.

In the inference device 1, the first inference unit 121 of the inference unit 12 may infer the driving assistance information when the determination unit 14 determines to output the driving assistance information.

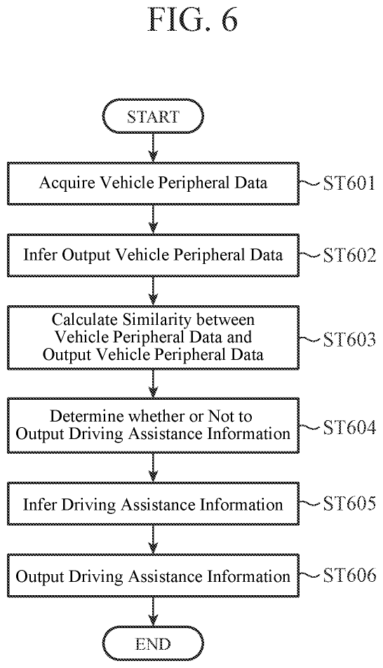

FIG. 6 is a flowchart for explaining the operation of the inference device 1 in a case where the first inference unit 121 infers driving assistance information after the determination unit 14 determines to output the driving assistance information in the first embodiment.

In FIG. 6, specific operations in steps ST601 to ST606 are similar to the specific operations in steps ST501, ST503 to ST505, ST502, and ST506 in FIG. 5, respectively.

The operation of the inference device 1 illustrated in the flowchart of FIG. 6 is different from the operation of the inference device 1 illustrated in the flowchart of FIG. 5 in that the operation in which the first inference unit 121 infers driving assistance information (step ST605) is after the determination unit 14 determines whether or not to output the driving assistance information (step ST604).

As illustrated in FIG. 6, by causing the first inference unit 121 to infer the driving assistance information after the determination unit 14 determines to output the driving assistance information, it is possible to omit unnecessary operation of inferring the driving assistance information by the first inference unit 121.

In general, accuracy of a machine learning model in supervised learning is improved by performing a test based on test data with a teacher label. However, at a stage where the machine learning model is actually used, it is impossible to prove that learning time data at the time of learning of the machine learning model is not biased with respect to data input in actual use. If data that has not been considered at the time of learning is input to the machine learning model at the time of inference in actual use, an erroneous inference result can be output.

On the other hand, the inference device 1 according to the first embodiment calculates the similarity between the output vehicle peripheral data inferred by inputting the vehicle peripheral data, which is to be input to the first machine learning model 16 and which is acquired at the time of inference in actual use, to the second machine learning model 17 and the acquired vehicle peripheral data, and compares the similarity with the threshold for inference result determination. As a result, the inference device 1 determines whether or not the acquired vehicle peripheral data has a feature close to that of the learning time data of the first machine learning model 16. Then, the inference device 1 determines whether or not to output the driving assistance information inferred by inputting the acquired vehicle peripheral data to the first machine learning model 16.

When the inference device 1 determines that the acquired vehicle peripheral data has a feature close to that of the learning time data of the first machine learning model 16 as a result of comparing the similarity with the threshold for inference result determination, the inference device 1 outputs the driving assistance information. That is, the inference device 1 outputs the driving assistance information in a state where reliability of the driving assistance information is secured. In other words, the inference device 1 can prevent output of an invalid inference result.

Note that, when the inference device 1 determines not to output the driving assistance information as a result of comparing the similarity with the threshold for inference result determination, the inference device 1 does not output the driving assistance information and outputs notification information providing notification that automatic driving is not possible. When the notification information is output from the inference device 1, the driving assistance device 100 does not perform automatic driving control based on the driving assistance information. The inference device 1 provides notification that the automatic driving is not possible, and thereby causes the driving assistance device 100 that performs the automatic driving control on the basis of the driving assistance information output from the inference device 1 not to perform the automatic driving control, so that reliability of the automatic driving control in the driving assistance device 100 can be improved.

As described above, according to the first embodiment, the inference device 1 includes: the data acquisition unit 11 that acquires data (vehicle peripheral data); the inference unit 12 that infers a first inference result (driving assistance information) by inputting the data acquired by the data acquisition unit 11 to the first machine learning model 16 that outputs the first inference result by using the data as an input; the similarity calculation unit 13 that calculates a similarity between the data acquired by the data acquisition unit 11 and a second inference result on the basis of the second inference result and the data acquired by the data acquisition unit 11, the second inference result being inferred by inputting the data acquired by the data acquisition unit 11 to the second machine learning model 17 that outputs the second inference result by using the data as an input; the determination unit 14 that determines whether or not to output the first inference result by comparing the similarity calculated by the similarity calculation unit 13 with the threshold for inference result determination; and the output unit 15 that outputs the first inference result when the determination unit 14 determines to output the first inference result. Therefore, the inference device 1 can prevent output of an invalid inference result.

### Second Embodiment

In the first embodiment, it is assumed that there is one first machine learning model 16 and one second machine learning model 17.

In a second embodiment, an embodiment in which an inference device 1a determines whether or not to output driving assistance information in a case where there is a plurality of first machine learning models 16 and a plurality of second machine learning models 17 will be described.

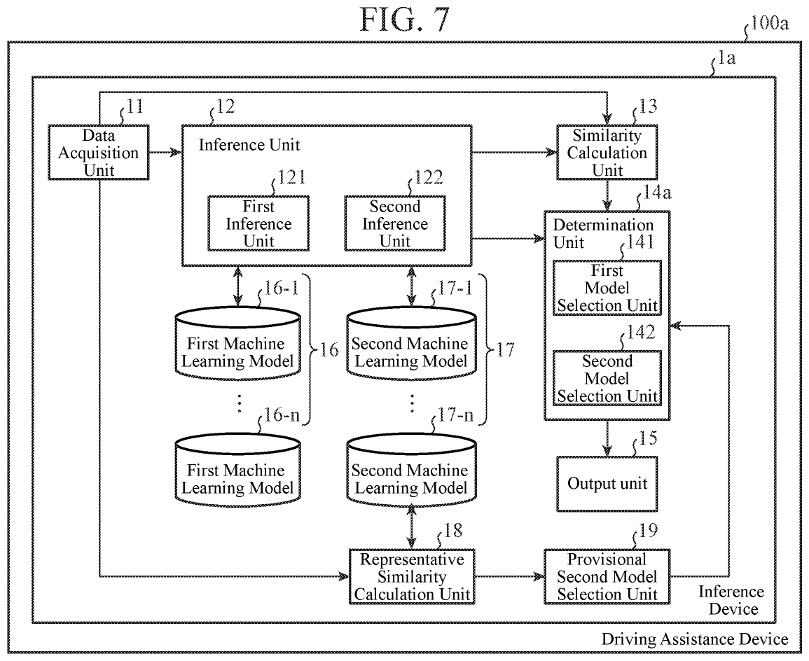

FIG. 7 is a diagram illustrating a configuration example of the inference device 1a according to the second embodiment.

In FIG. 7, the same components as the components of the inference device 1 described with reference to FIG. 1 in the first embodiment are denoted by the same reference numerals, and redundant description thereof is omitted.

In the second embodiment, there is a plurality of first machine learning models 16-1 to 16-n. In addition, there are second machine learning models 17-1 to 17-n corresponding to the first machine learning models 16-1 to 16-n, the number of the second machine learning models 17-1 to 17-n being the same as the number of the first machine learning models 16-1 to 16-n. The state in which the first machine learning models 16-1 to 16-n correspond to the second machine learning models 17-1 to 17-n means that the first machine learning models 16-1 to 16-n have learned on the basis of the same learning time data as the second machine learning models 17-1 to 17-n, respectively. That is, in the second embodiment, there is a plurality of pairs each of which includes a corresponding one of the first machine learning models 16-1 to 16-n and a corresponding one of the second machine learning models 17-1 to 17-n, and the corresponding one of the first machine learning models 16-1 to 16-n and the corresponding one of the second machine learning models 17-1 to 17-n have learned on the basis of the same learning time data.

The plurality of first machine learning models 16-1 to 16-n is used for the same purpose. To the plurality of first machine learning models 16-1 to 16-n, respective pieces of learning time data which are different from each other are input at the time of learning.

In the second embodiment, as an example, the first machine learning models 16-1 to 16-n are machine learning models used for the purpose of acquiring information indicating that an object has been recognized, similarly to the first machine learning model 16 in the first embodiment.

In the second embodiment, the plurality of first machine learning models 16-1 to 16-n is also collectively referred to as first machine learning models 16. In addition, the plurality of second machine learning models 17-1 to 17-n is also collectively referred to as second machine learning models 17.

The inference device 1a performs parallel computation or sequential computation on the second machine learning models 17 to select one second machine learning model 17 (hereinafter referred to as “select second machine learning model”) from the plurality of second machine learning models 17.

When selecting the select second machine learning model, the inference device 1a selects a first machine learning model 16 (hereinafter referred to as “select first machine learning model”) corresponding to the select second machine learning model.

The inference device 1a determines whether or not to output driving assistance information inferred by the select first machine learning model.

Details of the parallel computation or sequential computation performed on the second machine learning models 17 by the inference device 1a and a method of selecting the select second machine learning model and the select first machine learning model in the inference device 1a will be described later.

The inference device 1a according to the second embodiment is different from the inference device 1 according to the first embodiment in that a representative similarity calculation unit 18 and a provisional second model selection unit 19 are included.

In addition, the inference device 1a according to the second embodiment is different from the inference device 1 according to the first embodiment in that a determination unit 14a includes a first model selection unit 141 and a second model selection unit 142. In addition, the inference device 1a according to the second embodiment is different from the inference device 1 according to the first embodiment in operations of the inference unit 12 and the similarity calculation unit 13.

The first inference unit 121 of the inference unit 12 infers driving assistance information for each first machine learning model 16. Since the specific method by which the first inference unit 121 infers the driving assistance information using the first machine learning model 16 has been described in the first embodiment, detailed description thereof will be omitted.

The first inference unit 121 outputs the inferred driving assistance information of each first machine learning model 16 to the determination unit 14a. The first inference unit 121 outputs the driving assistance information to the determination unit 14a in association with information that makes it possible to identify the first machine learning model 16 that has inferred the driving assistance information.

The second inference unit 122 of the inference unit 12 infers output vehicle peripheral data for each second machine learning model 17. Since the specific method by which the second inference unit 122 infers the output vehicle peripheral data using the second machine learning model 17 has been described in the first embodiment, detailed description thereof will be omitted.

The second inference unit 122 outputs the inferred output vehicle peripheral data of each second machine learning model 17 to the similarity calculation unit 13. The second inference unit 122 outputs the output vehicle peripheral data to the similarity calculation unit 13 in association with information that makes it possible to identify the second machine learning model 17 that has inferred the output vehicle peripheral data.

The similarity calculation unit 13 calculates similarities for all the second machine learning models 17. Specifically, for each second machine learning model 17, on the basis of the output vehicle peripheral data inferred by the second inference unit 122 and vehicle peripheral data acquired by the data acquisition unit 11, the similarity calculation unit 13 calculates a similarity between the vehicle peripheral data acquired by the data acquisition unit 11 and the inferred output vehicle peripheral data. Since the specific method by which the similarity calculation unit 13 calculates the similarity has been described in the first embodiment, detailed description thereof will be omitted.

The similarity calculation unit 13 outputs the calculated similarity of each second machine learning model 17 to the determination unit 14a. The similarity calculation unit 13 outputs the similarity of each second machine learning model 17 to the determination unit 14a in association with the information that makes it possible to identify the second machine learning model 17.

A configuration of the inference device 1a will be described separately for a case where the inference device 1a performs parallel computation and thereby selects a select second machine learning model and a case where the inference device 1a performs sequential computation and thereby selects a select second machine learning model.

First, each component of the inference device 1a in a case where the inference device 1a performs parallel computation and thereby selects a select second machine learning model will be described. Note that, among the components of the inference device 1a, the same component as that of the inference device 1 that has been already described will not be described repeatedly.

The determination unit 14a sets a threshold for inference result determination for each pair of a first machine learning model 16 and a second machine learning model 17 corresponding to each other. A method of setting the threshold for inference result determination by the determination unit 14a is similar to that of the threshold for inference result determination by the determination unit 14 described in the first embodiment, and thus detailed description thereof will be omitted.

Note that the threshold for inference result determination may be set in advance and stored in a storage unit (not illustrated).

The second model selection unit 142 of the determination unit 14a selects a select second machine learning model from among the second machine learning models 17 by comparing the similarities calculated by the similarity calculation unit 13 with the thresholds for inference result determination.

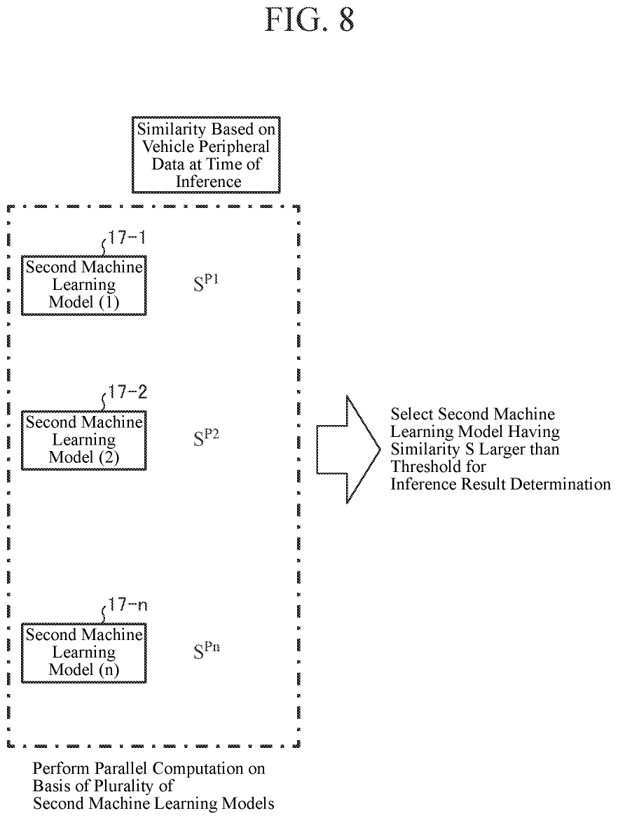

FIG. 8 is a diagram illustrating an example of a concept of a method in which the second model selection unit 142 selects a select second machine learning model by comparing the similarity for each second machine learning model 17 calculated by the similarity calculation unit 13 with the threshold for inference result determination in the second embodiment.

For example, the second model selection unit 142 selects one second machine learning model 17 whose similarity is larger than the threshold for inference result determination among the plurality of second machine learning models 17 as the select second machine learning model.

In a case where there is a plurality of second machine learning models 17 each of which has a similarity larger than the threshold for inference result determination, the second model selection unit 142 selects, for example, a second machine learning model 17 for which the largest similarity has been calculated as the select second machine learning model.

The second model selection unit 142 outputs information regarding the selected select second machine learning model to the first model selection unit 141.

In a case where there is no second machine learning model 17 whose similarity is larger than the threshold for inference result determination, the second model selection unit 142 does not select the select second machine learning model. The second model selection unit 142 outputs information indicating that the select second machine learning model has not been selected to the first model selection unit 141.

The first model selection unit 141 selects a select first machine learning model corresponding to the select second machine learning model selected by the second model selection unit 142. The first model selection unit 141 outputs information regarding the selected select first machine learning model to the determination unit 14a.

When the information indicating that the select second machine learning model has not been selected is output from the second model selection unit 142, the first model selection unit 141 does not select the select first machine learning model. The first model selection unit 141 outputs information indicating that the select first machine learning model has not been selected to the determination unit 14a.

When the information regarding the select first machine learning model is output from the first model selection unit 141, the determination unit 14a determines to output driving assistance information inferred by the first inference unit 121 on the basis of the select first machine learning model.

When the information indicating that the select first machine learning model has not been selected is output from the first model selection unit 141, the determination unit 14a determines not to output any driving assistance information inferred by the first inference unit 121.

The determination unit 14a outputs, to the output unit 15, a determination result as to whether or not to output the driving assistance information inferred by the first inference unit 121. When determining to output the driving assistance information inferred by the first inference unit 121, the determination unit 14a outputs the driving assistance information determined to be output to the output unit 15 in association with the determination result. Specifically, the determination unit 14a outputs the driving assistance information inferred by the first inference unit 121 on the basis of the select first machine learning model.

Next, each component of the inference device 1a in a case where the inference device 1a performs sequential computation and thereby selects a select second machine learning model will be described. Note that, among the components of the inference device 1a, the same component as that of the inference device 1 described in the first embodiment will not be described repeatedly.

In a case where the inference device 1a selects a select second machine learning model by performing sequential computation, similarities are calculated in advance for each second machine learning model 17 which are similarities between pieces of vehicle peripheral data as pieces of learning time data of the second machine learning models 17 and pieces of output vehicle peripheral data as pieces of output data inferred by inputting the pieces of learning time data to the second machine learning model 17 (hereinafter referred to as “learning time data similarities”). The learning time data similarities are stored in the storage unit as learning time similarity information. The learning time similarity information includes, for each second machine learning model 17, learning time data similarities calculated on the basis of pieces of learning time data of all the second machine learning models 17. Specifically, for example, the learning time similarity information includes, for the second machine learning model 17-1, a learning time data similarity between learning time data of the second machine learning model 17-1 and output data inferred by inputting the learning time data of the second machine learning model 17-1 to the second machine learning model 17-1, a learning time data similarity between learning time data of the second machine learning model 17-2 and output data inferred by inputting the learning time data of the second machine learning model 17-2 to the second machine learning model 17-1, . . . , a learning time data similarity between learning time data of the second machine learning model 17-n and output data inferred by inputting the learning time data of the second machine learning model 17-n to the second machine learning model 17-1. Similarly, for the second machine learning models 17-2 to 17-n, the learning time similarity information includes a learning time data similarity between the learning time data of the second machine learning model 17-1 and output data inferred by inputting the learning time data of the second machine learning model 17-1 to the second machine learning model 17-2, a learning time data similarity between the learning time data of the second machine learning model 17-2 and output data inferred by inputting the learning time data of the second machine learning model 17-2 to the second machine learning model 17-2, . . . , and a learning data similarity between the learning time data of the second machine learning model 17-n and output data inferred by inputting the learning time data of the second machine learning model 17-n to the second machine learning model 17-n.

The learning time similarity information is generated, for example, at the time of learning of the second machine learning models 17.

The representative similarity calculation unit 18 calculates a similarity between vehicle peripheral data acquired by the data acquisition unit 11 and output vehicle peripheral data inferred by inputting the vehicle peripheral data to a certain second machine learning model 17 (hereinafter referred to as “representative second machine learning model”) among the plurality of second machine learning models 17 (hereinafter referred to as “representative similarity”).

The representative similarity calculation unit 18 sets, as the representative second machine learning model, a second machine learning model 17 freely selected from among the plurality of second machine learning models 17.

The representative similarity calculation unit 18 may calculate the representative similarity in the same manner as the similarity calculation unit 13 calculates the similarity.

The representative similarity calculation unit 18 outputs the calculated representative similarity to the provisional second model selection unit 19.

The provisional second model selection unit 19 selects one second machine learning model 17 (hereinafter, referred to as “provisional second machine learning model”) from the plurality of second machine learning models 17 on the basis of the representative similarity calculated by the representative similarity calculation unit 18 and the learning time similarity information.

Specifically, the provisional second model selection unit 19 identifies a learning time data similarity closest to the representative similarity among the learning time data similarities included in the learning time similarity information. The provisional second model selection unit 19 selects, as the provisional second machine learning model, a second machine learning model 17 for which the identified learning time data similarity has been calculated.

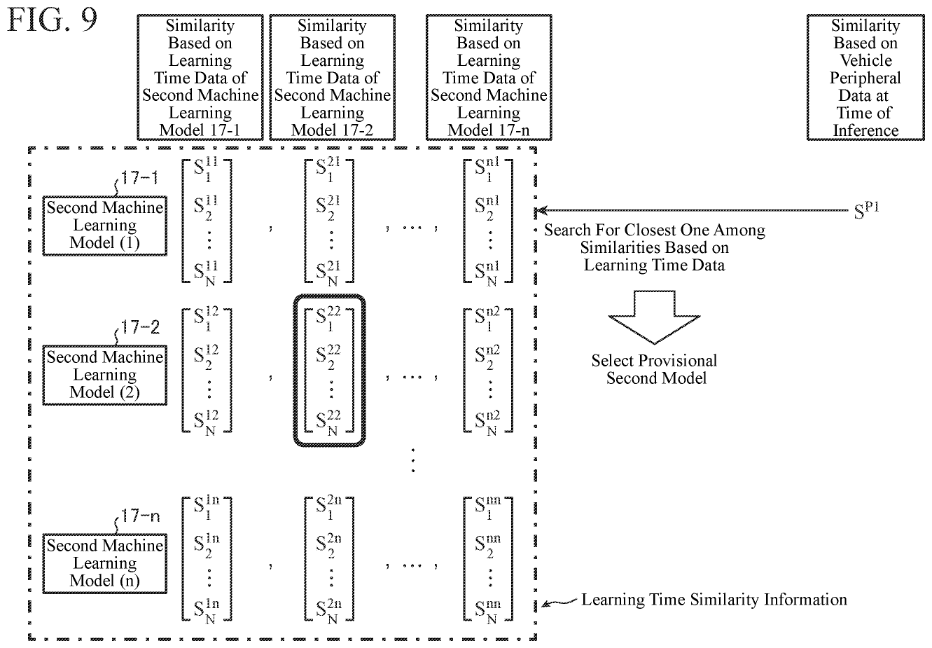

FIG. 9 is a diagram illustrating an example of a concept of a method in which the provisional second model selection unit 19 selects a provisional second machine learning model on the basis of a representative similarity calculated by the representative similarity calculation unit 18 and learning time similarity information in the second embodiment.

FIG. 9 illustrates, as an example, that a learning time data similarity closest to the representative similarity calculated by the representative similarity calculation unit 18 is a similarity between learning time data of the second machine learning model (2) 17-2 and output data inferred by inputting the learning time data to the second machine learning model (2) 17-2.

In this case, the provisional second model selection unit 19 selects the second machine learning model (2) 17-2 as the provisional second machine learning model.

The provisional second model selection unit 19 outputs information regarding the selected provisional second machine learning model to the determination unit 14a.

The second model selection unit 142 of the determination unit 14a selects a select second machine learning model by comparing a similarity calculated on the basis of the provisional second machine learning model with a threshold for inference result determination.

The similarity calculated on the basis of the provisional second machine learning model is a similarity calculated by the similarity calculation unit 13 between the vehicle peripheral data acquired by the data acquisition unit 11 and output vehicle peripheral data inferred by inputting the vehicle peripheral data to the provisional second machine learning model.

When the similarity calculated on the basis of the provisional second machine learning model is larger than the threshold for inference result determination, the second model selection unit 142 selects the provisional second machine learning model as the select second machine learning model. The second model selection unit 142 outputs information regarding the selected select second machine learning model to the first model selection unit 141.

When the similarity calculated on the basis of the provisional second machine learning model is equal to or less than the threshold for inference result determination, the second model selection unit 142 does not select the select second machine learning model. The second model selection unit 142 outputs information indicating that the select second machine learning model has not been selected to the first model selection unit 141.

The first model selection unit 141 selects a select first machine learning model corresponding to the select second machine learning model selected by the second model selection unit 142. The first model selection unit 141 outputs information regarding the selected select first machine learning model to the determination unit 14a.

When the information indicating that the select second machine learning model has not been selected is output from the second model selection unit 142, the first model selection unit 141 does not select the select first machine learning model. The first model selection unit 141 outputs information indicating that the select first machine learning model has not been selected to the determination unit 14a.

When the information regarding the select first machine learning model is output from the first model selection unit 141, the determination unit 14a determines to output driving assistance information inferred by the first inference unit 121 on the basis of the select first machine learning model.

When the information indicating that the select first machine learning model has not been selected is output from the first model selection unit 141, the determination unit 14a determines not to output any driving assistance information inferred by the first inference unit 121.

The determination unit 14a outputs, to the output unit 15, a determination result as to whether or not to output the driving assistance information inferred by the first inference unit 121. When determining to output the driving assistance information inferred by the first inference unit 121, the determination unit 14a outputs the driving assistance information determined to be output to the output unit 15 in association with the determination result. Specifically, the determination unit 14a outputs the driving assistance information inferred by the first inference unit 121 on the basis of the select first machine learning model.

As described above, the representative similarity calculation unit 18 and the provisional second model selection unit 19 function only when the inference device 1a performs the sequential computation to select the select second machine learning model.

In a case where the inference device 1a adopts only a method of performing the parallel computation when selecting the select second machine learning model, the inference device 1a may be configured not to include the representative similarity calculation unit 18 and the provisional second model selection unit 19. In this case, it is not essential that the learning time similarity information is stored.

However, in a case where the inference device 1a performs the sequential computation to select the select second machine learning model, the select second machine learning model can be selected without calculating the similarities on the basis of the acquired vehicle peripheral data and all the second machine learning models. Therefore, a processing load can be reduced as compared with a case where the parallel computation is performed to select the select second machine learning model.

The operation of the inference device 1a according to the second embodiment will be described.

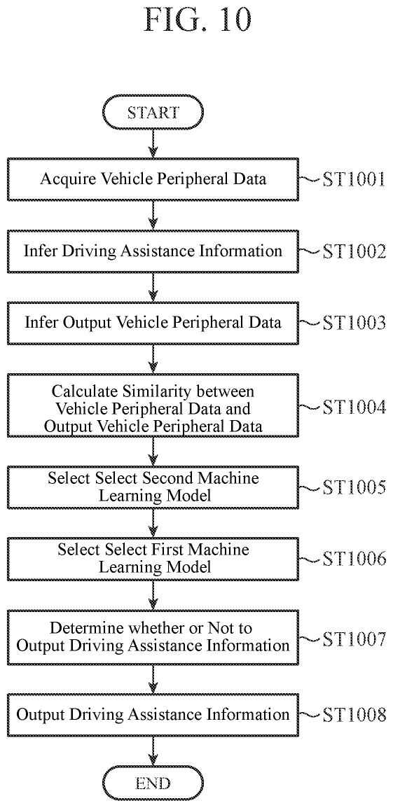

FIG. 10 is a flowchart for explaining the operation of the inference device 1a according to the second embodiment.

In FIG. 10, specific operations in steps ST1001 and ST1008 are similar to the specific operations in steps ST501 and ST506 in FIG. 5 described in the first embodiment, and thus duplicate description will be omitted.

The first inference unit 121 of the inference unit 12 infers driving assistance information for each first machine learning model 16 (step ST1002).

The first inference unit 121 outputs the inferred driving assistance information of each first machine learning model 16 to the determination unit 14a. The first inference unit 121 outputs the driving assistance information to the determination unit 14a in association with information that makes it possible to identify the first machine learning model 16.

The second inference unit 122 of the inference unit 12 infers output vehicle peripheral data for each second machine learning model 17 (step ST1003).

The second inference unit 122 outputs the inferred output vehicle peripheral data to the similarity calculation unit 13. The second inference unit 122 outputs the output vehicle peripheral data to the similarity calculation unit 13 in association with information that makes it possible to identify the second machine learning model 17.

The similarity calculation unit 13 calculates similarities for all the second machine learning models 17 (step ST1004).

The similarity calculation unit 13 outputs the calculated similarity of each second machine learning model 17 to the determination unit 14a. The similarity calculation unit 13 outputs the similarity of each second machine learning model 17 to the determination unit 14a in association with the information that makes it possible to identify the second machine learning model 17.

The second model selection unit 142 of the determination unit 14a selects a select second machine learning model from among the plurality of second machine learning models 17 by comparing the similarity calculated by the similarity calculation unit 13 in step ST1004 with a threshold for inference result determination (step ST1005).

A specific operation of step ST1005 will be described separately for a case where the inference device 1a performs parallel computation to select a select second machine learning model and a case where the inference device 1a performs sequential computation to select a select second machine learning model.

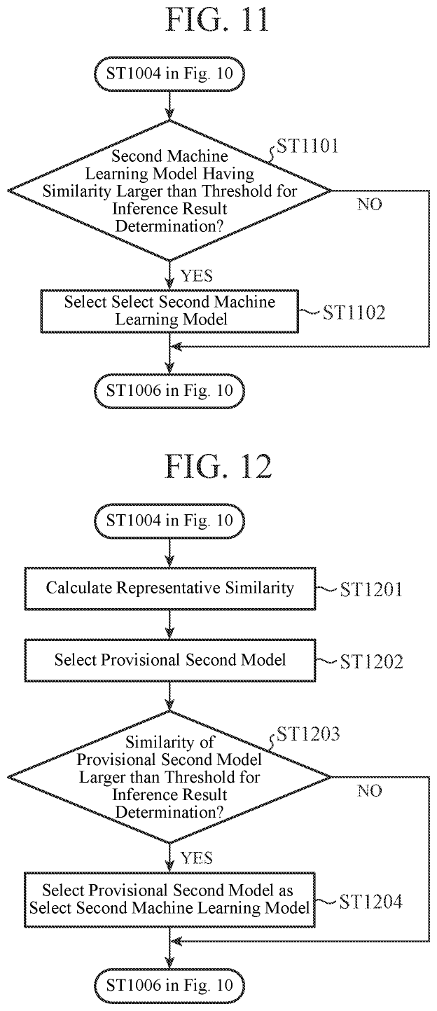

FIG. 11 is a flowchart for explaining the specific operation of step ST1005 in FIG. 10 in a case where the inference device 1a performs parallel computation to select a select second machine learning model.

The second model selection unit 142 of the determination unit 14a selects a select second machine learning model from among the second machine learning models 17 by comparing the similarity calculated by the similarity calculation unit 13 in step ST1004 of FIG. 10 with the threshold for inference result determination.

Specifically, for example, the second model selection unit 142 determines whether there is a second machine learning model 17 having a similarity larger than the threshold for inference result determination among the plurality of second machine learning models 17 (step ST1101).

In step ST1101, if there is a second machine learning model 17 having a similarity larger than the threshold for inference result determination (a case of “YES” in step ST1101), the second model selection unit 142 selects the second machine learning model 17 having the similarity larger than the threshold for inference result determination as the select second machine learning model (step ST1102).

The second model selection unit 142 outputs information regarding the selected select second machine learning model to the first model selection unit 141.

In step ST1101, if there is no second machine learning model 17 having a similarity larger than the threshold for inference result determination (a case of “NO” in step ST1101), the second model selection unit 142 does not select the select second machine learning model. The second model selection unit 142 outputs information indicating that the select second machine learning model has not been selected to the first model selection unit 141.

The operation of the inference device 1a proceeds to step ST1006 in FIG. 10.

FIG. 12 is a flowchart for explaining the specific operation of step ST1005 in FIG. 10 in a case where the inference device 1a performs sequential computation to select a select second machine learning model.

The representative similarity calculation unit 18 calculates a representative similarity between the vehicle peripheral data acquired by the data acquisition unit 11 in step ST1001 of FIG. 10 and the output vehicle peripheral data inferred by inputting the vehicle peripheral data to the representative second machine learning model (step ST1201).

The representative similarity calculation unit 18 outputs the calculated representative similarity to the provisional second model selection unit 19.

The provisional second model selection unit 19 selects one provisional second machine learning model from the plurality of second machine learning models 17 on the basis of the representative similarity calculated by the representative similarity calculation unit 18 in step ST1201 and learning time similarity information (step ST1202).

Specifically, the provisional second model selection unit 19 identifies a learning time data similarity closest to the representative similarity among the learning time data similarities included in the learning time similarity information. The provisional second model selection unit 19 selects, as the provisional second machine learning model, a second machine learning model 17 for which the identified learning time data similarity has been calculated.

The provisional second model selection unit 19 outputs information regarding the selected provisional second machine learning model to the determination unit 14a.

The second model selection unit 142 of the determination unit 14a selects a select second machine learning model by comparing a similarity calculated on the basis of the provisional second machine learning model with a threshold for inference result determination.

Specifically, for example, the second model selection unit 142 determines whether or not the similarity calculated on the basis of the provisional second machine learning model is larger than the threshold for inference result determination (step ST1203).

If it is determined in step ST1203 that the similarity calculated on the basis of the provisional second machine learning model is larger than the threshold for inference result determination (a case of “YES” in step ST1203), the second model selection unit 142 selects the provisional second machine learning model as the select second machine learning model.

The second model selection unit 142 outputs information regarding the selected select second machine learning model to the first model selection unit 141.

If it is determined in step ST1203 that the similarity calculated on the basis of the provisional second machine learning model is equal to or less than the threshold for inference result determination (a case of “NO” in step ST1203), the second model selection unit 142 does not select the select second machine learning model. The second model selection unit 142 outputs information indicating that the select second machine learning model has not been selected to the first model selection unit 141.

The operation of the inference device 1a proceeds to step ST1006 in FIG. 10.

Description returns to the flowchart of FIG. 10.

The first model selection unit 141 selects a select first machine learning model corresponding to the select second machine learning model selected by the second model selection unit 142 (step ST1006). The first model selection unit 141 outputs information regarding the selected select first machine learning model to the determination unit 14a.

When the information indicating that the select second machine learning model has not been selected is output from the second model selection unit 142, the first model selection unit 141 does not select the select first machine learning model. The first model selection unit 141 outputs information indicating that the select first machine learning model has not been selected to the determination unit 14a.

The determination unit 14a determines whether or not to output driving assistance information (step ST1007).

Specifically, when the information regarding the select first machine learning model is output from the first model selection unit 141 in step ST1006, the determination unit 14a determines to output the driving assistance information inferred by the first inference unit 121 on the basis of the select first machine learning model.

When the information indicating that the select first machine learning model has not been selected is output from the first model selection unit 141 in step ST1006, the determination unit 14a determines not to output any driving assistance information inferred by the first inference unit 121.

The determination unit 14a outputs, to the output unit 15, a determination result as to whether or not to output the driving assistance information inferred by the first inference unit 121. When determining to output the driving assistance information inferred by the first inference unit 121, the determination unit 14a outputs the driving assistance information determined to be output to the output unit 15 in association with the determination result. Specifically, the determination unit 14a outputs the driving assistance information inferred by the first inference unit 121 on the basis of the select first machine learning model.

Note that, in FIG. 10, the operation of the inference device 1a is performed in the order of step ST1002 and then step ST1003, but the order of the operation of step ST1002 and the operation of step ST1003 may be reversed in FIG. 10.

Further, in the operation description using FIG. 10, in the inference device 1a, the first inference unit 121 of the inference unit 12 infers the driving assistance information (step ST1002) before the determination unit 14a determines whether or not to output the driving assistance information (step ST1007), and the determination unit 14a outputs the driving assistance information inferred by the first inference unit 121 when determining to output the driving assistance information. However, this is merely an example.

In the inference device 1a, the first inference unit 121 of the inference unit 12 may infer the driving assistance information when the determination unit 14a determines to output the driving assistance information.

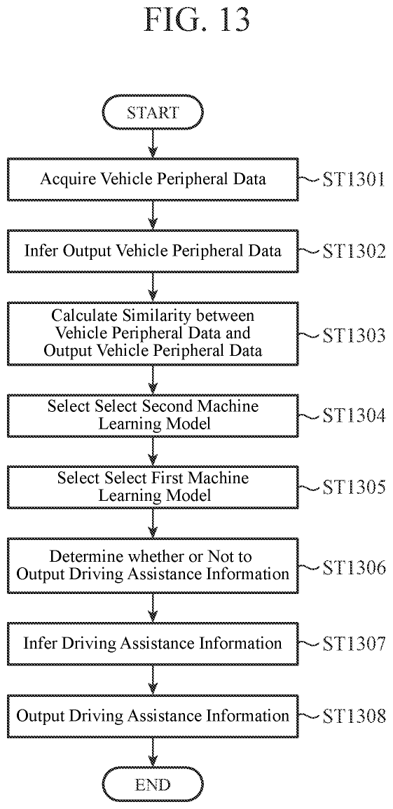

FIG. 13 is a flowchart for explaining the operation of the inference device 1a in a case where the first inference unit 121 infers driving assistance information after the determination unit 14a determines to output the driving assistance information in the second embodiment.

In FIG. 13, specific operations in steps ST1301 to ST1308 are similar to the specific operations in steps ST1001, ST1003 to ST1007, ST1002, and ST1008 in FIG. 10, respectively.

The operation of the inference device 1a illustrated in the flowchart of FIG. 13 is different from the operation of the inference device 1a illustrated in the flowchart of FIG. 10 in that the operation in which the first inference unit 121 infers the driving assistance information (step ST1307) is after the determination unit 14a determines whether or not to output the driving assistance information (step ST1306).

As illustrated in FIG. 13, by causing the first inference unit 121 to infer the driving assistance information after the determination unit 14a determines to output the driving assistance information, it is possible to omit unnecessary operation of inferring the driving assistance information by the first inference unit 121.

As described above, when there is a plurality of pairs each of which includes a corresponding one of the first machine learning models 16 and a corresponding one of the second machine learning models 17, and the corresponding one of the first machine learning models 16 and the corresponding one of the second machine learning models 17 have learned on the basis of the same learning time data, the inference device 1a calculates, for each second machine learning model 17, the similarity between the output vehicle peripheral data inferred by inputting the vehicle peripheral data acquired during actual use to the second machine learning model 17 and the acquired vehicle peripheral data, and compares the similarity with the threshold for inference result determination, thereby selecting the select second machine learning model from among the plurality of second machine learning models 17. Then, the inference device 1a selects the select first machine learning model corresponding to the select second machine learning model, and outputs the driving assistance information inferred by the first inference unit 121 on the basis of the select first machine learning model.

Even in a case where there is a plurality of first machine learning models 16 and second machine learning models 17, the inference device 1a outputs the driving assistance information when determining that the acquired vehicle peripheral data has a feature close to that of the learning time data of the first machine learning model 16. That is, the inference device 1a outputs the driving assistance information in a state where reliability of the driving assistance information is secured. In other words, the inference device 1a can prevent output of an invalid inference result.

Note that, similarly to the inference device 1 according to the first embodiment, when determining not to output the driving assistance information, the inference device 1a does not output the driving assistance information and outputs notification information providing notification that automatic driving is not possible. When the notification information is output from the inference device 1a, the driving assistance device 100 does not perform automatic driving control based on the driving assistance information. The inference device 1a provides notification that the automatic driving is not possible, and thereby causes the driving assistance device 100 that performs the automatic driving control on the basis of the driving assistance information output from the inference device 1a not to perform the automatic driving control, so that reliability of the automatic driving control in the driving assistance device 100 can be improved.

As described above, according to the second embodiment, in a case where there is a plurality of pairs each of which includes a corresponding one of the first machine learning models 16 and a corresponding one of the second machine learning models 17, and the corresponding one of the first machine learning models 16 and the corresponding one of the second machine learning models 17 have learned on the basis of the same learning time data, the inference device 1a is configured as described below. The inference unit 12 can infer the first inference result (driving assistance information) for each first machine learning model 16. The similarity calculation unit 13 can calculate the similarity for each second machine learning model 17. The determination unit 14a includes: the second model selection unit 142 that selects the select second machine learning model from among the plurality of second machine learning models 17 by comparing the similarity calculated by the similarity calculation unit 13 with the threshold for inference result determination; and the first model selection unit 141 that selects the select first machine learning model corresponding to the select second machine learning model selected by the second model selection unit 142 from among the plurality of first machine learning models 16, and determines whether or not to output the first inference result inferred by the inference unit 12 on the basis of the select first machine learning model selected by the first model selection unit 141. Therefore, the inference device 1a can prevent output of an invalid inference result.

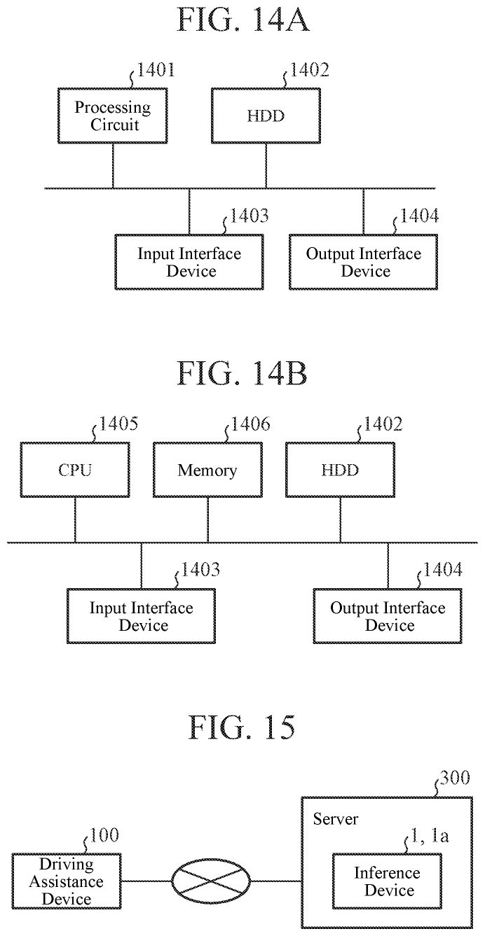

FIGS. 14A and 14B are diagrams each illustrating an example of a hardware configuration of the inference device 1 according to the first embodiment or the inference device 1a according to the second embodiment.

In the first and second embodiments, functions of the data acquisition unit 11, the inference unit 12, the similarity calculation unit 13, the determination unit 14, 14a, the output unit 15, the representative similarity calculation unit 18, and the provisional second model selection unit 19 are implemented by a processing circuit 1401. That is, the inference device 1, 1a includes the processing circuit 1401 for performing control to determine whether or not to output the driving assistance information inferred on the basis of the first machine learning model 16 by comparing the similarity calculated on the basis of the second machine learning model 17 with the threshold for inference result determination.

The processing circuit 1401 may be dedicated hardware as illustrated in FIG. 14A, or may be a central processing unit (CPU) 1405 that executes a program stored in a memory 1406 as illustrated in FIG. 14B.

When the processing circuit 1401 is dedicated hardware, the processing circuit 1401 corresponds to, for example, a single circuit, a composite circuit, a programmed processor, a parallel programmed processor, an application specific integrated circuit (ASIC), a field-programmable gate array (FPGA), or a combination thereof.

When the processing circuit 1401 is the CPU 1405, the functions of the data acquisition unit 11, the inference unit 12, the similarity calculation unit 13, the determination unit 14, 14a, the output unit 15, the representative similarity calculation unit 18, and the provisional second model selection unit 19 are implemented by software, firmware, or a combination of software and firmware. That is, the data acquisition unit 11, the inference unit 12, the similarity calculation unit 13, the determination unit 14, 14a, the output unit 15, the representative similarity calculation unit 18, and the provisional second model selection unit 19 are implemented by the CPU 1405 that executes a program stored in a hard disk drive (HDD) 1402, the memory 1406, or the like, or the processing circuit 1401 such as a system large-scale integration (LSI). Further, it can also be said that the program stored in the HDD 1402, the memory 1406, or the like causes a computer to execute procedures or methods performed by the data acquisition unit 11, the inference unit 12, the similarity calculation unit 13, the determination unit 14, 14a, the output unit 15, the representative similarity calculation unit 18, and the provisional second model selection unit 19. Here, the memory 1406 corresponds to, for example, a nonvolatile or volatile semiconductor memory such as a RAM, a read only memory (ROM), a flash memory, an erasable programmable read only memory (EPROM), or an electrically erasable programmable read-only memory (EEPROM), a magnetic disk, a flexible disk, an optical disk, a compact disk, a mini disk, a digital versatile disc (DVD), or the like.

Note that the functions of the data acquisition unit 11, the inference unit 12, the similarity calculation unit 13, the determination unit 14, 14a, the output unit 15, the representative similarity calculation unit 18, and the provisional second model selection unit 19 may be partially implemented by dedicated hardware and partially implemented by software or firmware. For example, the functions of the data acquisition unit 11 and the output unit 15 can be implemented by the processing circuit 1401 as dedicated hardware, and the functions of the inference unit 12, the similarity calculation unit 13, the determination unit 14, 14a, the representative similarity calculation unit 18, and the provisional second model selection unit 19 can be implemented by the processing circuit 1401 reading and executing the program stored in the memory 1406.

In addition, the inference device 1, 1a includes an input interface device 1403 and an output interface device 1404 that perform wired communication or wireless communication with a device such as the driving assistance device 100.

In the first and second embodiments described above, the second machine learning model 17 is a machine learning model that has performed learning by using the same input data as the first machine learning model 16 so that the input data and the output data that is the second inference result are equal to each other. However, this is merely an example.

The second machine learning model 17 may be a binary classification machine learning model that has performed learning by using the input data as a correct label. The binary classification machine learning model learns all input data as correct data, and outputs information indicating abnormality when input data including a feature amount different from that of the input data input at the time of learning is input at the time of inference based on the machine learning model. A typical method of the binary classification machine learning model is a method called one class support vector machine (OC-SVM).

Further, in the first and second embodiments described above, the inference device 1, 1a is provided in the driving assistance device 100 mounted on the vehicle, but this is merely an example.

For example, the inference device 1, 1a may be provided in a server and output the driving assistance information to the driving assistance device 100 mounted on the vehicle, which is an external device with respect to the inference device 1, 1a, via a network.

FIG. 15 is a diagram illustrating a configuration example of an inference system in which the inference device 1 according to the first embodiment or the inference device 1a according to the second embodiment is provided in a server 300, and the server 300 and a vehicle (not illustrated) are connected via a network.

Further, in the first embodiment and the second embodiment described above, the inference device 1, 1a is provided in the driving assistance device 100 mounted on the vehicle, and determines whether or not to output the driving assistance information inferred on the basis of the first machine learning model 16. However, this is merely an example. The inference devices 1 and 1a according to the first and second embodiments can be applied to various devices that need to perform output control of information inferred on the basis of a learned model.

Note that it is possible to freely combine embodiments, modify any components in the embodiments, or omit any components in the embodiments.

### INDUSTRIAL APPLICABILITY

Since the inference device according to the present disclosure is configured to be able to prevent output of an invalid inference result, it can be applied to an inference device that performs inference using a machine learning model.

### REFERENCE SIGNS LIST

1, 1a: inference device, 11: data acquisition unit, 12: inference unit, 121: first inference unit, 122: second inference unit, 13: similarity calculation unit, 14, 14a: determination unit, 141: first model selection unit, 142: second model selection unit, 15: output unit, 16: first machine learning model, 17: second machine learning model, 18: representative similarity calculation unit, 19: provisional second model selection unit, 100: driving assistance device, 300: server, 1401: processing circuit, 1402: HDD, 1403: input interface device, 1404: output interface device, 1405: CPU, 1406: memory.

1. An inference device comprising:
processing circuitry
to acquire data;
to infer a first inference result by inputting the data acquired to at least one first machine learning model that outputs the first inference result by using the data as an input;
to calculate a similarity between the data acquired and a second inference result on a basis of the second inference result and the data acquired, the second inference result being inferred by inputting the data acquired to at least one second machine learning model that outputs the second inference result by using the data as an input;
to determine whether or not to output the first inference result by comparing the similarity calculated with a threshold for inference result determination; and
to output the first inference result in a case where it is determined that the first inference result is to be output.

2. The inference device according to claim 1, wherein
the processing circuitry infers the first inference result before the processing circuitry determines whether or not to output the first inference result, and
the processing circuitry determines whether or not to output the first inference result that has been inferred by the processing circuitry.

3. The inference device according to claim 1, wherein
the processing circuitry infers the first inference result after the processing circuitry determines to output the first inference result.

4. The inference device according to claim 1, wherein
the processing circuitry
determines to output the first inference result when the similarity is larger than the threshold for inference result determination.

5. The inference device according to claim 1, wherein
the threshold for inference result determination
is set on a basis of
a correct data similarity between correct test data and a correct inference result calculated on a basis of the correct test data and the correct inference result, the correct test data causing a correct first inference result to be output when the correct test data is input to the first machine learning model at a time of testing the first machine learning model, the correct inference result being output by inputting the correct test data to the second machine learning model,
and
an incorrect data similarity between incorrect test data and an incorrect inference result calculated on a basis of the incorrect test data and the incorrect inference result, the incorrect test data causing an incorrect first inference result to be output when the incorrect test data is input to the first machine learning model at a time of testing the first machine learning model, the incorrect inference result being output by inputting the incorrect test data to the second machine learning model.

6. The inference device according to claim 1, wherein
the second machine learning model is a machine learning model that has performed learning so that the data used as an input and the second inference result are equal.

7. The inference device according to claim 1, wherein
there is a plurality of pairs each of which includes a corresponding one of first machine learning models included in the at least one first machine learning model and a corresponding one of second machine learning models included in the at least one second machine learning model, and the corresponding one of the first machine learning models and the corresponding one of the second machine learning models have learned on a basis of same learning time data,
the processing circuitry is capable of inferring the first inference result for each of the first machine learning models,
the processing circuitry is capable of calculating the similarity for each of the second machine learning models,
the processing circuitry selects a select second machine learning model from among the second machine learning models by comparing the similarity calculated with the threshold for inference result determination,
the processing circuitry selects a select first machine learning model corresponding to the select second machine learning model selected from among the first machine learning models, and
the processing circuitry determines whether or not to output the first inference result inferred on a basis of the select first machine learning model selected.

8. The inference device according to claim 7, wherein
the processing circuitry calculates the similarity for each of the second machine learning models, and
the processing circuitry selects the select second machine learning model by comparing the similarity calculated for each of the second machine learning models with the threshold for inference result determination.

9. The inference device according to claim 7, wherein
the processing circuitry calculates a representative similarity between the data acquired and the second inference result inferred by inputting the data to a representative second machine learning model among the second machine learning models,
the processing circuitry selects a provisional second machine learning model from among the second machine learning models on a basis of the representative similarity calculated and learning time data similarities, each of the learning time data similarities being a similarity between a corresponding one of pieces of learning time data input to the respective first machine learning models at a time of learning of the first machine learning models and a corresponding one of second inference results inferred by inputting the corresponding one of the pieces of learning time data to the second machine learning models, and
the processing circuitry
selects the select second machine learning model by comparing a similarity calculated between the data acquired and the second inference result inferred by inputting the data acquired to the provisional second machine learning model with the threshold for inference result determination.

10. A driving assistance device comprising
the inference device according to claim 1.

11. An inference method comprising:
acquiring data;
inferring a first inference result by inputting the data acquired to at least one first machine learning model that outputs the first inference result by using the data as an input;
calculating a similarity between the data acquired and a second inference result on a basis of the second inference result and the data acquired, the second inference result being inferred by inputting the data acquired to at least one second machine learning model that outputs the second inference result by using the data as an input;
determining whether or not to output the first inference result by comparing the similarity calculated with a threshold for inference result determination; and
outputting the first inference result in a case where it is determined that the first inference result is to be output.

12. A server comprising:
processing circuitry
to acquire data;
to infer a first inference result by inputting the data acquired to at least one first machine learning model that outputs the first inference result by using the data as an input;
to calculate a similarity between the data acquired and a second inference result on a basis of the second inference result and the data acquired, the second inference result being inferred by inputting the data acquired to at least one second machine learning model that outputs the second inference result by using the data as an input;
to determine whether or not to output the first inference result by comparing the similarity calculated with a threshold for inference result determination; and
to output the first inference result to an external device in a case where it is determined that the first inference result is to be output.
